(19) United States
(12) Patent Application Publication
(10) Pub. No.: US 2025/0263559 A1
(43) Pub. Date: Aug. 21, 2025

(54) LIQUID SUBSTANCE, AND METHOD AND SYSTEM FOR PRODUCING POROUS REINFORCED RESIN ARTICLE

(71) Applicants: Yuuma USUI, Kanagawa (JP); Tatsuki YAMAGUCHI, Kanagawa (JP); Yusuke KOMINE, Kanagawa (JP); Soyoung PARK, Kanagawa (JP); Yasunori TAKAHASHI, Kanagawa (JP)

(72) Inventors: Yuuma USUI, Kanagawa (JP); Tatsuki YAMAGUCHI, Kanagawa (JP); Yusuke KOMINE, Kanagawa (JP); Soyoung PARK, Kanagawa (JP); Yasunori TAKAHASHI, Kanagawa (JP)

(21) Appl. No.: 19/053,421

(22) Filed: Feb. 14, 2025

(30) Foreign Application Priority Data
Feb. 15, 2024 (JP) 2024-020826
Oct. 30, 2024 (JP) 2024-190965

(51) Int. Cl. C09D 7/43; C08K 3/34; C08K 7/02; C09D 5/02; C09D 7/20; C09D 7/61; D06M 15/244; D06M 15/71

(52) U.S. Cl. CPC C09D 7/43; C08K 3/346; C08K 7/02; C09D 5/024; C09D 7/20; C09D 7/61; D06M 15/244; D06M 15/71

(57) ABSTRACT

A liquid substance includes a film-forming agent; and functional particles, and has a viscosity of 1 Pa·s to 100 Pa·s at a shear rate of 0.1 (1/s); and a viscosity of 1 mPa·s to 100 mPa·s at a shear rate of 1,000 (1/s). The liquid substance may include a thickener including at least one of a resin, a carbon nanotube, a cellulose nanofiber; or a layered clay mineral.

### CROSS-REFERENCE TO RELATED APPLICATIONS

This patent application is based on and claims priority pursuant to 35 U.S.C. § 119 (a) to Japanese Patent Application No. 2024-020826, filed on Feb. 15, 2024, in the Japan Patent Office and Japanese Patent Application No. 2024-190965, filed on Oct. 30, 2024, in the Japan Patent Office, the entire disclosure of which are hereby incorporated by reference herein.

### BACKGROUND

### Technical Field

The present disclosure relates to a liquid substance, a method for producing a porous reinforced resin article, and a system for producing a porous reinforced resin article.

### Related Art

A technique of patterning a liquid containing functional particles on a porous medium such as a fiber sheet by an inkjet method to impart a predetermined function to the porous medium is known.

For example, an inkjet recording method has been proposed in the related art in which a pigment textile printing ink substance is discharged from a nozzle of a liquid discharger and is adhered to a fabric.

However, in the related art, there is a problem that the pattern accuracy and uniformity are poor.

### SUMMARY

According to an embodiment of the present disclosure, a liquid substance includes a film-forming agent and functional particles, and has a viscosity of 1 Pa·s to 100 Pa·s at a shear rate of 0.1 (1/s) and a viscosity of 1 mPa·s to 100 mPa·s at a shear rate of 1,000 (1/s).

According to an embodiment of the present disclosure, in a method for producing a porous reinforced resin article, the method includes applying the liquid substance to a predetermined region in a porous medium to impregnate the predetermined region in the porous medium with the liquid substance and drying the porous medium applied with the liquid substance.

According to an embodiment of the present disclosure, a system includes a liquid applier to apply the liquid substance to a predetermined region in a porous medium to impregnate the predetermined region in the porous medium with the liquid substance and a dryer to dry the porous medium applied with the liquid substance, to produce a porous reinforced resin article.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a flowchart of a method for producing a porous reinforced resin article according to an embodiment of the present disclosure; and

FIG. 2 is a schematic diagram illustrating a system for producing a porous reinforced resin article according to an embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to an embodiment of the present disclosure, a liquid substance having a high pattern accuracy and uniformity to a porous medium can be provided.

### Liquid Substance

A liquid substance according to an embodiment of the present disclosure includes a film forming agent and functional particles, preferably includes a thickener, and may further include other components as necessary.

Since a liquid substance according to an embodiment of the present disclosure includes a film forming agent, a film in a gap of a porous medium. According to an embodiment of the present disclosure, since a liquid substance for imparting a function to a porous medium (sometimes referred to as “liquid for porous medium”) includes functional particles, a predetermined function can be added to the porous medium.

Film Forming Agent

The film forming agent is a material that forms a continuous film on the surface of the porous medium. The film-forming agent forms a continuous film by the resin particles being bonded or fused to each other when the dispersion medium evaporates after the film-forming agent is applied. As the film forming agent, for example, a resin emulsion can be used. In the resin emulsion, resin particles are dispersed in water as a dispersant. Since a liquid substance includes a film forming agent, a film in a gap of a porous medium such as a fiber sheet can be formed.

The type of the film forming agent is not particularly limited and can be appropriately selected depending on the purpose, and examples thereof include resin emulsions containing at least one of an acrylic resin, a urethane resin, a silicone resin, an acryl-styrene copolymer, an acryl-urethane copolymer, an acryl-silicone copolymer, a polyester copolymer, a vinyl chloride resin, and a vinyl acetate resin as a main component. These may be used alone or in combination thereof.

Among these film forming agents, a vinyl chloride resin, an acrylic-silicone copolymer, an acrylic-styrene copolymer, and an acrylic-urethane copolymer are preferable.

The film forming agent may be appropriately synthesized, or a commercially available product may be used. Examples of commercially available products include VINYBLAN 755 (polyvinyl chloride resin emulsion, manufactured by Nissin Chemical Industry Co., Ltd.), VINYBLAN 278 (polyvinyl chloride resin emulsion, manufactured by Nissin Chemical Industry Co., Ltd.), VINYBLAN 690 (polyvinyl chloride resin emulsion, manufactured by Nissin Chemical Industry Co., Ltd.), VINYBLAN 700 (polyvinyl chloride resin emulsion, manufactured by Nissin Chemical Industry Co., Ltd.), VINYBLAN 715S (polyvinyl chloride resin emulsion, manufactured by Nissin Chemical Industry Co., Ltd.), VONCOAT SA-6360 (acrylic-silicone resin emulsion, manufactured by DIC Corporation), VONCOAT CG-8400 (acrylic-styrene resin emulsion, manufactured by DIC Corporation), VONCOAT 5400EF (acrylic-styrene resin emulsion, manufactured by DIC Corporation), and VONCOAT CG-5010EF (acrylic-urethane resin emulsion, manufactured by DIC Corporation).

The average particle diameter (hydrodynamic diameter (cumulant diameter) measured by a dynamic light scattering method) of the resin particles contained in the film forming agent is not particularly limited and can be appropriately selected depending on the purpose, but is preferably 10 nanometers (nm) or more and 500 nm or less.

Although the measurement method of a particle diameter is not particularly limited and can be appropriately selected depending on the purpose, for example, a particle diameter analyzer FPAR-1000 (manufactured by Otsuka Electronics Co., Ltd.) can be used.

The minimum film forming temperature (MFT) of a film forming agent is the lowest temperature at which a film is formed. For example, it can be measured according to American Society for Testing and Materials (ASTM) D2354. The minimum film forming temperature of the film forming agent is not particularly limited and can be appropriately selected depending on the purpose, but is preferably 0° C. or more and 100° C. or less, and more preferably 20° C. or more and 80° C. or less from the viewpoint that the pattern accuracy and uniformity are good and the film can be formed when the film forming agent is heated on the porous medium while preventing the film formation when the film forming agent is applied.

The content of the film forming agent is not particularly limited and can be appropriately selected depending on the purpose, but is preferably 0.1 mass % or more and 10.0 mass % or less, and preferably 1.0 mass % or more and 2.0 mass % or less, with respect to the total amount of the liquid substance. When the content is 0.1 mass % or more, a film can be formed in the gap of the porous medium. When the content is 10.0 mass % or less, the liquid substance has a good pattern accuracy and uniformity.

The glass transition temperature Tg (° C.) of the film forming agent is not particularly limited and can be appropriately selected depending on the purpose, but is preferably−50° C. or more and 90° C. or less.

Functional Particle

The functional particle is a material for imparting a predetermined function to the porous medium. The shape of the functional particles is not particularly limited and can be appropriately selected depending on the purpose, and examples thereof include spherical, needle-like, and plate shapes.

The type of the functional particles is not particularly limited and can be appropriately selected depending on the purpose, and examples thereof include silver, copper, aluminum, titanium, carbon, and pigment. Using silver, copper, or aluminum as the functional particles can impart conductivity to the porous medium. Further, using titanium, carbon, or a pigment as the functional particles can impart coloring properties to the porous medium.

As the functional particles, commercially available products may be used. Examples of the commercially available product include JS-A191 (silver nanoparticle dispersion, manufactured by NovaCentrix) and JS-A211 (aqueous silver nano ink, containing a fluorine-based binder polymer, manufactured by NovaCentrix).

The average particle diameter of the functional particles is not particularly limited and can be appropriately selected depending on the purpose, but is preferably 10 nm or more and 10,000 nm or less. The particle diameter can be measured by, for example, the same method as that for measuring the particle diameter of the film forming agent.

The ratio A/B of the average particle diameter A of the functional particles to the average particle diameter B of the film forming agent is not particularly limited and can be appropriately selected depending on the purpose, but is preferably 0.1 to 10. When the ratio A/B is 0.1 or more, a film can be formed on the gaps of the fiber sheet as the porous medium, and when the ratio A/B is 10 or less, a film can be formed in a state where the functional particles are appropriately exposed. As a result, a predetermined function can be imparted.

The content of the functional particles is not particularly limited and can be appropriately selected depending on the purpose, but is preferably 10.0 mass % or more and 50.0 mass % or less, and more preferably 30.0 mass % or more and 40.0 mass % or less, with respect to the total amount of the liquid substance. When the content is 10.0 mass % or more and 50.0 mass % or less, a predetermined function can be easily imparted to the porous medium.

### Thickener

A thickener is used to increase the viscosity of a liquid substance. For example, the thickener is a thickener in which 1 gram (g) of the thickener is dissolved in 100 milliliter (mL) of water, and the viscosity at 25° C. increases by 100% after the solution is left to be still for 60 minutes. Since a liquid substance includes a film forming agent, a film in a gap of a porous medium such as a fiber sheet can be formed.

The kind of the thickener is not particularly limited and can be appropriately selected depending on the purpose, and examples thereof include resins, carbon nanotubes, cellulose nanofibers, and layered clay minerals. These may be used alone or in combination thereof.

Among these materials, resin is preferably used in terms of good pattern accuracy and uniformity.

The resin is not particularly limited and can be appropriately selected depending on the purpose, and examples thereof include a polyacrylic resin, a polyamide resin, and a polyurethane resin. Among these resins, polyamide resins are preferred.

Examples of the polyamide resin include polyamide, modified polyamide, and fatty acid polyamide.

Examples of the layered clay mineral include bentonite, hectorite, kaolinite, montmorillonite, sericite (silk mica), and illite. These may be used alone or in combination thereof. Among these layered clay minerals, bentonite and hectorite are preferred.

The film forming agent may be appropriately synthesized, or a commercially available product may be used. Examples of commercially available products include AQ-633E (modified polyamide, manufactured by Kusumoto Chemicals, Ltd.), AQH-800 (modified polyamide, manufactured by Kusumoto Chemicals, Ltd.), RHEOBYK-425 (urea-modified polyurethane, manufactured by BYK Japan K.K.), RHEOBYK-430 (urea-modified polyamide, manufactured by BYK Japan K.K.), RHEOBYK-431 (urea-modified polyamide, manufactured by BYK Japan K.K.), RHEOCRYSTA I-2SX (cellulose nanofiber, manufactured by DKS Co. Ltd.), NCD-001 (single-walled carbon nanotube dispersion, manufactured by Kusumoto Kasci Co., Ltd.), LAPONITE-RD (synthetic hectorite, manufactured by BYK), OPTIGEL-CK (Na-substituted bentonite, manufactured by BYK), AEROSIL200® (hydrophilic fumed silica, manufactured by Nippon Acrosil Co., Ltd.), and PFA-131 (fatty acid amide wax, manufactured by Kusumoto Chemicals, Ltd.).

The content of the thickener is not particularly limited and can be appropriately selected depending on the purpose, but is preferably 0.1 mass % or more and 10.0 mass % or less, and preferably 0.2 mass % or more and 2.0 mass % or less, with respect to the total amount of the liquid substance. When the content is 0.1 mass % or more, thixotropy can be imparted to the liquid substance, and a film can be formed in a gap of the porous medium by preventing the flow of the liquid substance after the thickener is applied to the porous medium. When the content is 10.0 mass % or less, the liquid substance has a good pattern accuracy and uniformity.

Other Components

The other components are not particularly limited and can be appropriately selected depending on the purpose, and examples thereof include solvents such as organic solvents and water.

Since the liquid substance contains the solvent, the liquid substance can be prevented from drying. As a result, poor application due to clogging of the head nozzle with the liquid substance can be prevented.

Organic Solvent

The organic solvent is not particularly limited and can be appropriately selected depending on the purpose, and examples thereof include a water-soluble organic solvent.

Examples of the water-soluble organic solvent include ethers including polyhydric alcohols, polyhydric alcohol alkyl ethers, and polyhydric alcohol aryl ethers, nitrogen-containing heterocyclic compounds, amides, amines, sulfur-containing compounds, propylene carbonate, and ethylene carbonate.

Examples of the polyhydric alcohols include ethylene glycol, diethylene glycol, 1,2-propanediol, 1,3-propanediol, 1,2-butanediol, 1,3-butanediol, 1,4-butanediol, 2,3-butanediol, 3-methyl-1,3-butanediol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butanetriol, 1,2,3-butanetriol, 2,2,4-trimethyl-1,3-pentanediol, and petoriol (3-methylpentane-1,3,5-triol).

Examples of the polyhydric alcohol alkyl ethers include ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether.

Examples of the polyhydric alcohol aryl ethers include ethylene glycol monophenyl ether, and ethylene glycol monobenzyl ether.

Examples of the nitrogen-containing heterocyclic compound include 2-pyrrolidone, N-methyl-2-pyrrolidone, N-hydroxyethyl-2-pyrrolidone, 1,3-dimethyl-2-imidazolidinone, &-caprolactam, and γ-butyrolactone.

Examples of the amides include formamide, N-methylformamide, N,N-dimethylformamide, 3-methoxy-N,N-dimethylpropionamide, and 3-butoxy-N,N-dimethylpropionamide.

Examples of the amines include monoethanolamine, diethanolamine, and triethylamine.

Examples of the sulfur-containing compounds include dimethyl sulfoxide, sulfolane, and thiodiethanol.

The boiling point of the organic solvent is not particularly limited and can be appropriately selected depending on the purpose, but is preferably 250° C. or less because the organic solvent functions as a wetting agent and also provides good drying properties.

The content of the organic solvent is not particularly limited and can be appropriately selected depending on the purpose, but is preferably 10.0 mass % or more and 60.0 mass % or less, and more preferably 20.0 mass % or more and 60.0 mass % or less, with respect to the total amount of the liquid substance, from the viewpoint of the drying property, pattern accuracy, and uniformity of the liquid substance.

### Water

The content of water is not particularly limited and can be appropriately selected depending on the purpose, but is preferably 10.0 mass % or more and 90.0 mass % or less, and more preferably 20.0 mass % or more and 60.0 mass % or less, from the viewpoint of drying properties, pattern accuracy, and uniformity of the liquid substance.

The viscosity of the liquid substance at a shear rate of 0.1 (1/s) at 25° C. is 1 pascal second (Pa·s) or more and 100 Pa·s or less. The viscosity at a shear rate of 1,000 (1/s) at 25° C. is 1 millipascal second (mPa·s) to 100 mPa·s.

The measurement method for the viscosity of the liquid substance is not particularly limited and can be appropriately selected depending on the purpose. For example, the viscosity of the liquid substance can be measured by a rheometer MCR-302 (manufactured by Anton Paar).

The method for producing the liquid substance is not particularly limited and can be appropriately selected according to the purpose, and for example, the liquid substance can be obtained by adding a thickener, a film forming agent, and, if necessary, a solvent such as an organic solvent or water, mixing and stirring the mixture at 3,000 round per minute (rpm) for 15 minutes with a homogenizer, and filtering the mixture using a 10 micrometer (μm) PP membrane filter.

Method for Producing Porous Reinforced Resin Article and System for Producing Porous Reinforced Resin Article

The method for producing a porous reinforced resin article according to an embodiment of the present disclosure includes an applying process to apply a liquid substance onto a porous medium, and a drying process to dry the porous medium, and further includes a heating process, a moving process, a spraying process, and a laminating process as necessary.

The system for producing a porous reinforced resin article according to an embodiment of the present disclosure includes an applying apparatus to apply a liquid substance onto a porous medium, a dryer to dry the porous medium, and further includes other apparatus such as a heater, a spraying apparatus, and a laminating apparatus as necessary.

An embodiment of the present disclosure is described below in detail with reference to the drawings.

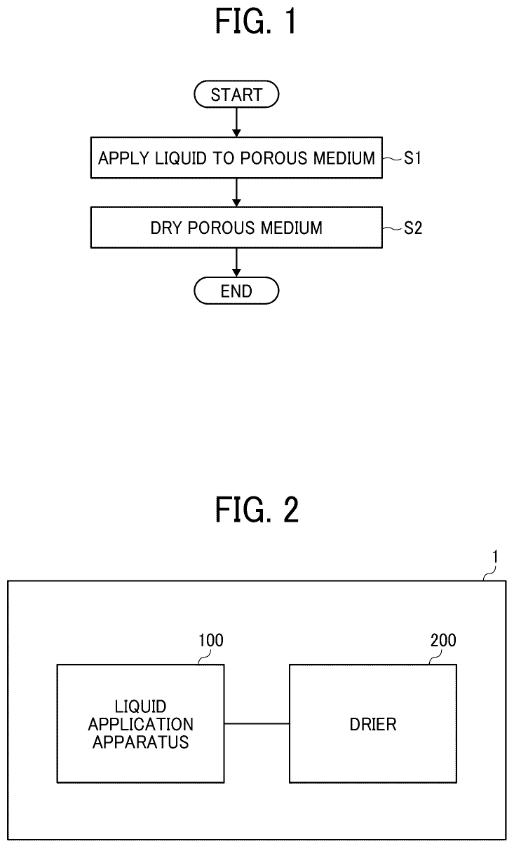

FIG. 1 is a flowchart of a method for producing a porous reinforced resin article according to an embodiment of the present disclosure. The method for producing a porous reinforced resin article includes an applying process (step S1) and a drying process (step S2), and is carried out in this order. The drying process may include a heating process, and the applying process may include a moving process.

FIG. 2 is a schematic diagram illustrating a system for producing a porous reinforced resin article according to an embodiment of the present disclosure. The system for producing a porous reinforced resin article includes an applying apparatus 100 and a dryer 200. The applying process (step S1) is performed by the applying apparatus 100, and the drying process (step S2) is performed by the dryer 200.

### Applying Process and Applying Apparatus

In the applying process (step S1), a liquid substance is applied onto a porous medium. The applying forms a pattern, for example, on a predetermined region of the porous medium. In the applying process (step S1), the region impregnated with the liquid substance, i.e., the pattern arrangement is adjusted so that the physical properties such as strength and impact resistance of the porous reinforced resin article can be adjusted.

The applying process can be performed by an applying apparatus.

The applying apparatus is not particularly limited as long as it uses a method that can impregnate the liquid substance, and can be appropriately selected according to the purpose. For example, the liquid substance may be discharged onto the porous medium by an inkjet nozzle, or the liquid substance may be applied onto the porous medium by hand.

As the pattern arrangement, the liquid substance may be regularly impregnated on the porous medium, or the liquid substance may be irregularly impregnated on the porous medium. Examples of the pattern arrangement in which the liquid substance is regularly impregnated on the porous medium include stripes and grids.

### Porous Medium

A porous medium is a medium that contains multiple voids within a solid material. Examples of the solid material include fibers, metals, and zeolites. The type of the fiber is not particularly limited and can be appropriately selected depending on the purpose, and examples thereof include glass fiber, carbon fiber, flax fiber, boron fiber, and aramid fiber. Among these fibers, glass fiber, carbon fiber, or flax fiber is preferable from the viewpoint of increasing the strength of the porous reinforced resin article. These fibers may be used singly or in combination of two or more. The fiber volume fraction of the fiber is not particularly limited and can be appropriately selected depending on the purpose, but is preferably 10% or less. In order to prevent the liquid substance from bleeding into the fibers, the surface may be treated as appropriate.

### Drying Process and Drying Apparatus

In the drying process (step S2), the porous medium impregnated with the liquid substance is dried. The drying process can be carried out by a drying apparatus.

The drying apparatus is not particularly limited as long as it can remove the organic solvent and water contained in the liquid substance impregnated in the porous medium, and may be appropriately selected according to the purpose. Examples thereof include a hot air dryer and a vacuum dryer.

The drying temperature is not particularly limited, but is preferably 50° C. or more and 300° C. or less, and more preferably 80° C. or more and 200° C. or less. The drying temperature is preferably 80° C. or more and 200° C. or less in view of the compatibility between the case of formation of a film and the heat resistance of the resin and the fiber.

### Other Processes and Other Apparatus

Other processes are not particularly limited and can be appropriately selected depending on the purpose, and examples thereof include a heating process, a moving process, a spraying process, and a laminating process. Other apparatuses are not particularly limited and can be appropriately selected depending on the purpose, and examples thereof include a heating apparatus, a moving apparatus, a spraying apparatus, and a laminating apparatus. Heating Process and Heating Apparatus

In the heating process, the porous medium is heated. The heating process may be performed before or after the applying process. The heating process can be carried out by a heating apparatus. The drying process may include the heating process.

The heating apparatus is not particularly limited and can be appropriately selected depending on the purpose, and examples thereof include a silicon rubber heater.

The heating temperature is not particularly limited and can be appropriately selected depending on the purpose, but is preferably 80° C. or more and 200° C. or less. The heating temperature is the surface temperature of the heating apparatus.

### Moving Process and Moving Apparatus

In the moving process, the porous medium is moved. The moving process is a process performed between the processes. The moving process may be performed by a moving apparatus. The applying process may include the moving process.

The moving apparatus is not particularly limited and can be appropriately selected according to the purpose, and examples thereof include a belt conveyor.

### Spraying Process and Spraying Apparatus

In the spraying process, the matrix resin is sprayed onto the region on the porous medium that is not impregnated with the liquid substance. Accordingly, a porous reinforced resin composite is obtained. The spraying process can be performed by a spraying apparatus. In the present disclosure, the term “porous reinforced resin composite” indicates a composite in which a liquid substance and a matrix resin are applied to a porous medium. A porous reinforced resin composite obtained by laminating multiple porous reinforced resin composites in the laminating process is also included in the porous reinforced resin composite. The “porous reinforced resin article” indicates an article obtained by forming a porous reinforced resin composite by heating and pressurizing.

The spraying apparatus is not particularly limited as long as the matrix resin can be sprayed onto the region of the porous medium not impregnated with the liquid substance, and the matrix resin may be sprayed manually.

### Matrix Resin

The type of the matrix resin is not particularly limited and can be appropriately selected depending on the purpose, and examples thereof include a urethane resin, a polyester resin, an acrylic resin, a vinyl acetate resin, a styrene resin, a butadiene resin, a styrene-butadiene resin, a vinyl chloride resin, an acryl-styrene resin, an acryl-silicone resin, a polyamide resin, a polyimide resin, a polyether resin, and a polyether ether ketone resin. Among these matrix resins, polyamide resin is preferable in view of heat resistance, chemical resistance, and material cost. These matrix resin may be used singly or in combination of two or more.

The melting point of the matrix resin is not particularly limited and can be appropriately selected depending on the purpose, but is preferably 400° C. or less, and more preferably 250° C. or less. The melting point of 250° C. or less is preferable in view of uniformly filling the porous medium with the matrix resin and the liquid substance. Laminating Process and Laminating Apparatus In the laminating process, multiple porous reinforced resin composites are laminated. The number of laminated porous reinforced resin composites is changed so that a porous reinforced resin composite having a predetermined thickness can be obtained. The laminating process can be performed by a laminating apparatus.

The laminating apparatus is not particularly limited as long as multiple porous reinforced resin composites can be laminated, and can be appropriately selected according to the purpose. According to the present embodiment, since multiple porous reinforced resin composites in which a liquid substance having a good pattern accuracy and uniformity is applied to a porous medium are laminated, a porous reinforced resin composite having a good pattern accuracy and uniformity and a predetermined thickness can be obtained.

### EXAMPLES

The following description will be given of examples of the present disclosure, but the present disclosure is not limited to the these examples. The term “part” in the examples indicates “part by mass” unless otherwise specified.

### Example 1

A container was charged with 7.0 parts by mass of a thickener AQ-633E (modified polyamide, manufactured by Kusumoto Chemicals, Ltd., active ingredient: 22.5%), 7.0 parts by mass of a film-forming agent VINYBLAN 755 (vinyl chloride, manufactured by Nissin Chemical Industry Co., Ltd., active ingredient: 25%, MFT: 20° C., Tg: 34° C. average particle diameter: 30 nm), and 86.0 parts by mass of functional particles JS-A191 (silver nanoparticle dispersion, manufactured by Novacentrix Co., Ltd., active ingredient: 40%, average particle diameter: 30 nm to 50 nm), and the mixture was stirred and mixed with a homogenizer (manufactured by Nippon Seiki Co., Ltd., ED-7 Excel Auto Homogenizer) at 3,000 rpm for 15 minutes to obtain a mixture. The obtained mixture was filtered through a PP membrane filter of 10 μm to obtain a liquid 1 for porous materials. The substance of the liquid 1 for porous materials is listed in Table 1.

### Example 2

A liquid 2 for porous materials was obtained in the same manner as in Example 1 except that 7.0 parts by mass of AQ-633E as a thickener was replaced with 7.0 parts by mass of AQH-800 (modified polyamide, manufactured by Kusumoto Chemicals, Ltd., active ingredient: 10%). The substance of the liquid 2 for porous materials is listed in Table 1.

### Example 3

A liquid 3 for porous materials was obtained in the same manner as in Example 1 except that 7.0 parts by mass of AQ-633E as a thickener was replaced with 3.0 parts by mass of RHEOBYK-425 (urea-modified polyurethane, manufactured by BYK Japan K.K., active ingredient: 50%). The substance of the liquid 3 for porous materials is listed in Table 1.

### Example 4

A liquid 4 for porous materials was obtained in the same manner as in Example 1 except that 7.0 parts by mass of AQ-633E as a thickener was replaced with 10.0 parts by mass of RHEOCRYSTA I-2SX (cellulose nanofiber, manufactured by DKS Co., Ltd., active ingredient: 2%). The substance of the liquid 4 for porous materials is listed in Table 1.

### Example 5

A liquid 5 for porous materials was obtained in the same manner as in Example 1 except that 7.0 parts by mass of AQ-633E as a thickener was replaced with 1.0 parts by mass of LAPONITE-RD (synthetic hectorite, manufactured by BYK, active ingredient: 100%). The substance of the liquid 5 for porous materials is listed in Table 1.

### Example 6

A liquid 6 for porous materials were obtained in the same manner as in Example 1 except that 7.0 parts by mass of AQ-633E as a thickener was replaced with 2.0 parts of AEROSIL200 (hydrophilic fumed silica, manufactured by Nippon Aerosil Co., Ltd., active ingredient: 100%). The substance of the liquid 6 for porous materials is listed in Table 2.

### Example 7

A liquid 7 for porous materials was obtained in the same manner as in Example 1 except that 7.0 parts by mass of VINYBLAN 755 as the film forming agent was replaced with 4.0 parts by mass of VINYBLAN 278 (vinyl chloride, manufactured by Nissin Chemical Industry Co., Ltd., active ingredient: 43%, MFT: 50° C., Tg: 30° C.). The substance of the liquid 7 for porous materials is listed in Table 2.

### Example 8

A liquid 8 for porous materials was obtained in the same manner as in Example 1 except that 7.0 parts by mass of VINYBLAN 755 as the film forming agent was replaced with 3.0 parts by mass of VINYBLAN 690 (vinyl chloride, manufactured by Nissin Chemical Industry Co., Ltd., active ingredient: 54%, MFT: 65° C., Tg: 45° C.). The substance of the liquid 8 for porous materials is listed in Table 2.

### Example 9

A liquid 9 for porous materials was obtained in the same manner as in Example 1 except that 7.0 parts by mass of VINYBLAN 755 as the film forming agent was replaced with 5.0 parts by mass of VINYBLAN 700 (vinyl chloride, manufactured by Nissin Chemical Industry Co., Ltd., active ingredient: 30%, MFT: 80° C., Tg: 70° C.). The substance of the liquid 9 for porous materials is listed in Table 2.

### Example 10

A liquid 10 for porous materials was obtained in the same manner as in Example 1 except that 7.0 parts by mass of VINYBLAN 755 as the film forming agent was replaced with 7.0 parts by mass of VINYBLAN 715S (vinyl chloride, manufactured by Nissin Chemical Industry Co., Ltd., active ingredient: 24%, MFT: 0° C., Tg: 25° C.). The substance of the liquid 10 for porous materials is listed in Table 2.

### Example 11

A liquid 11 for porous materials was obtained in the same manner as in Example 1 except that 7.0 parts by mass of VINYBLAN 755 as a film forming agent was replaced with 3.0 parts by mass of VONCOAT SA-6360 (acrylic-silicone resin emulsion, manufactured by DIC Corporation, active ingredient: 50%, MFT: 26 to 32° C., Tg: 21° C., average particle diameter: 150 nm). The substance of the liquid 11 for porous materials is listed in Table 3.

### Example 12

A liquid 12 for porous materials was obtained in the same manner as in Example 1 except that 7.0 parts by mass of VINYBLAN 755 as a film forming agent was replaced with 3.0 parts by mass of VONCOAT CG-8400 (acrylic-styrene resin emulsion, manufactured by DIC Corporation, active ingredient: 50%, MFT: 26 to 31° C., Tg: 25° C., average particle diameter: 150 to 200 nm) in Example 1. The substance of the liquid 12 for porous materials is listed in Table 3.

### Example 13

A liquid 13 for porous materials was obtained in the same manner as in Example 1 except that 7.0 parts by mass of VINYBLAN 755 as a film forming agent was replaced with 3.0 parts by mass of VONCOAT 5400EF (acrylic-styrene resin emulsion, manufactured by DIC Corporation, active ingredient: 55%, MFT: 5 to 10° C., Tg: 6° C., average particle diameter: 200 nm). The substance of the liquid 13 for porous materials is listed in Table 3.

### Example 14

A liquid 14 for porous materials was obtained in the same manner as in Example 1 except that 7.0 parts by mass of VINYBLAN 755 as a film forming agent was replaced with 3.0 parts by mass of VONCOAT CG-5010EF (acrylic-urethane resin emulsion, manufactured by DIC Corporation, active ingredient: 45%, MFT: 20 to 23° C., Tg: 29° C., average particle diameter: 100 nm to 150 nm). The substance of the liquid 14 for porous materials is listed in

Table 3.

### Example 15

A liquid 15 for porous materials was obtained in the same manner as in Example 1 except that 86.0 parts by mass of JS-A191 as the functional particles was replaced with 80.0 parts by mass and 6.0 parts by mass of ethylene glycol as the solvent was added. The substance of the liquid 15 for porous materials is listed in Table 3.

### Example 16

A liquid 16 for porous materials was obtained in the same manner as in Example 15 except that 6.0 parts by mass of ethylene glycol as the solvent was replaced with 6.0 parts by mass of glycerin. The substance of the liquid 16 for porous materials is listed in Table 3.

### Example 17

A liquid 17 for porous materials was obtained in the same manner as in Example 5 except that the amount of LAPONITE-RD (synthetic hectorite, manufactured by BYK, active ingredient: 100%) added as a thickener was replaced with 3.0 parts by mass. The substance of the liquid 17 for porous materials is listed in Table 3.

### Example 18

A liquid 18 for porous materials was obtained in the same manner as in Example 16 except that the amount of glycerin added as the solvent was changed to 10.0 parts by mass. The substance of the liquid 18 for porous materials is listed in Table 3.

### Comparative Example 1

A liquid 19 for porous materials was obtained in the same manner as in Example 1 except that VINYBLAN 755 as the film-forming agent was not added and the amount of JS-A191 as the functional particles was changed from 86.0 parts by mass to 93.0 parts by mass. The substance of the liquid 19 for porous materials is listed in Table 4.

### Comparative Example 2

A liquid 20 for porous materials was obtained in the same manner as in Example 1 except that the AQ 633E as the thickener was not added and the JS-A191 as the functional particles was changed from 86.0 parts by mass to 93.0 parts by mass. The substance of the liquid 20 for porous materials is listed in Table 4.

### Comparative Example 3

A liquid 21 for porous materials was obtained in the same manner as in Example 1 except that AQ-633E as a thickener and VINYBLAN 755 as a film forming agent were not added and JS-A191 as functional particles was changed from 86.0 parts by mass to 100.0 parts by mass. The substance of the liquid 21 for porous materials is listed in Table 4.

### Comparative Example 4

A liquid 22 for porous materials was obtained in the same manner as in Example 5 except that the amount of LAPONITE-RD (synthetic hectorite, manufactured by BYK, active ingredient: 100%) added as a thickener was changed to 4.0 parts by mass and VINYBLAN 755 as a film-forming agent was not added. The substance of the liquid 22 for porous materials is listed in Table 4.

### Comparative Example 5

A liquid 23 for porous material was obtained in the same manner as in Comparative Example 1 except that 12.0 parts by mass of glycerin as a solvent was added. The substance of the liquid 23 for porous materials is listed in Table 4.

TABLE 1

| | | example | | | | |
|---|---|---|---|---|---|---|
| | | 1 | 2 | 3 | 4 | 5 |
| liquid for porous material | | 1 | 2 | 3 | 4 | 5 |
| thickner | AQ-633E | 7.0 | — | — | — | — |
| | (modified polyamide, active | | | | | |
| | ingredient: 22.5%) | | | | | |
| | AQH-800 | — | 7.0 | — | — | — |
| | (modified polyamide, active | | | | | |
| | ingredient: 10.0%) | | | | | |
| | RHEOBYK-425 | — | — | 3.0 | — | — |
| | (modified polyamide, active | | | | | |
| | ingredient: 50.0%) | | | | | |
| | RHEOCRYSTA I-2SX | — | — | — | 10.0 | — |
| | (cellulose nanofibers, active | | | | | |
| | ingredient: 2.0%) | | | | | |
| | LAPONITE-RD | — | — | — | — | 1.0 |
| | (synthetic hectorite, active | | | | | |
| | ingredient: 100.0%) | | | | | |
| | AEROSIL 200 | — | — | — | — | — |
| | (hydrophilic fumed silica, | | | | | |
| | active ingredient: 100.0%) | | | | | |
| film- | VINYBLAN 755 | 7.0 | 7.0 | 7.0 | 7.0 | 7.0 |
| forming | (polyvinyl chloride resin | | | | | |
| agent | emulsion, active ingredient 25%, | | | | | |
| | MFT: 20° C., Tg: 34° C., average | | | | | |
| | particle diameter: 30 nm) | | | | | |
| | VINYBLAN 278 | — | — | — | — | — |
| | (polyvinyl chloride resin | | | | | |
| | emulsion, active ingredient | | | | | |
| | 43%, MFT: 50° C., Tg: 30° C.) | | | | | |
| | VINYBLAN 690 | — | — | — | — | — |
| | (polyvinyl chloride resin | | | | | |
| | emulsion, active ingredient | | | | | |
| | 54%, MFT: 65° C., Tg: 45° C.) | | | | | |
| | VINYBLAN 700 | — | — | — | — | — |
| | (polyvinyl chloride resin | | | | | |
| | emulsion, active ingredient | | | | | |
| | 30%, MFT: 80° C., Tg: 70° C.) | | | | | |
| | VINYBLAN 715S | — | — | — | — | — |
| | (polyvinyl chloride resin | | | | | |
| | emulsion, active ingredient | | | | | |
| | 24%, MFT: 0° C., Tg: 25° C.) | | | | | |
| | VONCOAT SA-6360 | — | — | — | — | — |
| | (acrylic-silicone resin emulsion, | | | | | |
| | active ingredient: 50%, MFT: 26 | | | | | |
| | to 32° C., Tg: 21° C., average | | | | | |
| | particle diameter: 150 nm) | | | | | |
| | VONCOAT CG-8400 | — | — | — | — | — |
| | (acrylic-styrene resin emulsion, | | | | | |
| | active ingredient: 50%, MFT: 26 | | | | | |
| | to 31° C., Tg: 25° C., average | | | | | |
| | article diameter: 150 to 200 nm) | | | | | |
| | VONCOAT 5400EF | — | — | — | — | — |
| | (acrylic-styrene resin emulsion, | | | | | |
| | active ingredient: 55%, MFT: 5 | | | | | |
| | to 10° C., Tg: 6° C., average | | | | | |
| | particle diameter: 200 nm) | | | | | |
| | VONCOAT CG -5010EF | — | — | — | — | — |
| | (acrylic-urethane resin emulsion, | | | | | |
| | active ingredient: 45%, MFT: 20 | | | | | |
| | to 23° C., Tg: 29° C., average | | | | | |
| | particle diameter: 100 to 150 nm) | | | | | |
| functional | JS-A191 | 86.0 | 86.0 | 86.0 | 86.0 | 86.0 |
| particles | (silver nanoparticle dispersion, | | | | | |
| | active ingredient: 40%, average | | | | | |
| | particle diameter: 30 to 50 nm) | | | | | |
| solvent | ethylene glycol | — | — | — | — | — |
| | glycerin | — | — | — | — | — |
| total (parts by mass) | | 100.0 | 100.0 | 96.0 | 103.0 | 94.0 |
| physical | ratio A/B of the average | 1 to 1.67 | 1 to 1.67 | 1 to 1.67 | 1 to 1.67 | 1 to 1.67 |
| property | particle diameter A of the | | | | | |
| value | functional particles to the | | | | | |
| | average particle diameter B | | | | | |
| | of the film forming agent | | | | | |

TABLE 2

| | | example | | | | |
|---|---|---|---|---|---|---|
| | | 6 | 7 | 8 | 9 | 10 |
| liquid for porous material | | 6 | 7 | 8 | 9 | 10 |
| thickner | AQ-633E | — | 7.0 | 7.0 | 7.0 | 7.0 |
| | (modified polyamide, active | | | | | |
| | ingredient: 22.5%) | | | | | |
| | AQH-800 | — | — | — | — | — |
| | (modified polyamide, active | | | | | |
| | ingredient: 10.0%) | | | | | |
| | RHEOBYK-425 | — | — | — | — | — |
| | (modified polyamide, active | | | | | |
| | ingredient: 50.0%) | | | | | |
| | RHEOCRYSTA I-2SX | — | — | — | — | — |
| | (cellulose nanofibers, active | | | | | |
| | ingredient: 2.0%) | | | | | |
| | LAPONITE-RD | — | — | — | — | — |
| | (synthetic hectorite, active | | | | | |
| | ingredient: 100.0%) | | | | | |
| | AEROSIL 200 | 2.0 | — | — | — | — |
| | (hydrophilic fumed silica, | | | | | |
| | active ingredient: 100.0%) | | | | | |
| film- | VINYBLAN 755 | 7.0 | — | — | — | — |
| forming | (polyvinyl chloride resin | | | | | |
| agent | emulsion, active ingredient 25%, | | | | | |
| | MFT: 20° C., Tg: 34° C., average | | | | | |
| | particle diameter: 30 nm) | | | | | |
| | VINYBLAN 278 | — | 4.0 | — | — | — |
| | (polyvinyl chloride resin | | | | | |
| | emulsion, active ingredient | | | | | |
| | 43%, MFT: 50° C., Tg: 30° C.) | | | | | |
| | VINYBLAN 690 | — | — | 3.0 | — | — |
| | (polyvinyl chloride resin | | | | | |
| | emulsion, active ingredient | | | | | |
| | 54%, MFT: 65° C., Tg: 45° C.) | | | | | |
| | VINYBLAN 700 | — | — | — | 5.0 | — |
| | (polyvinyl chloride resin | | | | | |
| | emulsion, active ingredient | | | | | |
| | 30%, MFT: 80° C., Tg: 70° C.) | | | | | |
| | VINYBLAN 715S | — | — | — | — | 7.0 |
| | (polyvinyl chloride resin | | | | | |
| | emulsion, active ingredient | | | | | |
| | 24%, MFT: 0° C., Tg: 25° C.) | | | | | |
| | VONCOAT SA-6360 | — | — | — | — | — |
| | (acrylic-silicone resin emulsion, | | | | | |
| | active ingredient: 50%, MFT: 26 | | | | | |
| | to 32° C., Tg: 21° C., average | | | | | |
| | particle diameter: 150 nm) | | | | | |
| | VONCOAT CG-8400 | — | — | — | — | — |
| | (acrylic-styrene resin emulsion, | | | | | |
| | active ingredient: 50%, MFT: 26 | | | | | |
| | to 31° C., Tg: 25° C., average | | | | | |
| | particle diameter: 150 to 200 nm) | | | | | |
| | VONCOAT 5400EF | — | — | — | — | — |
| | (acrylic-styrene resin emulsion, | | | | | |
| | active ingredient: 55%, MFT: 5 | | | | | |
| | to 10° C., Tg: 6° C., average | | | | | |
| | particle diameter: 200 nm) | | | | | |
| | VONCOAT CG -5010EF | — | — | — | — | — |
| | (acrylic-urethane resin emulsion, | | | | | |
| | active ingredient: 45%, MFT: 20 | | | | | |
| | to 23° C., Tg: 29° C., average | | | | | |
| | particle diameter: 100 to 150 nm) | | | | | |
| functional | JS-A191 | 86.0 | 86.0 | 86.0 | 86.0 | 86.0 |
| particles | (silver nanoparticle dispersion, | | | | | |
| | active ingredient: 40%, average | | | | | |
| | particle diameter: 30 to 50 nm) | | | | | |
| solvent | ethylene glycol | — | — | — | — | — |
| | glycerin | — | — | — | — | — |
| total (parts by mass) | | 95.0 | 97.0 | 96.0 | 98.0 | 100.0 |
| physical | ratio A/B of the average | 1 to 1.67 | — | — | — | — |
| property | particle diameter A of the | | | | | |
| value | functional particles to the | | | | | |
| | average particle diameter B | | | | | |
| | of the film forming agent | | | | | |

TABLE 3

| | | example | | | | | | | |
|---|---|---|---|---|---|---|---|---|---|
| | | 11 | 12 | 13 | 14 | 15 | 16 | 17 | 18 |
| liquid for porous material | | 11 | 12 | 13 | 14 | 15 | 16 | 17 | 18 |
| thickner | AQ-633E | 7.0 | 7.0 | 7.0 | 7.0 | 7.0 | 7.0 | — | 7.0 |
| | (modified polyamide, active | | | | | | | | |
| | ingredient: 22.5%) | | | | | | | | |
| | AQH-800 | — | — | — | — | — | — | — | — |
| | (modified polyamide, active | | | | | | | | |
| | ingredient: 10.0%) | | | | | | | | |
| | RHEOBYK-425 | — | — | — | — | — | — | — | — |
| | (modified polyamide, active | | | | | | | | |
| | ingredient: 50.0%) | | | | | | | | |
| | RHEOCRYSTA I-2SX | — | — | — | — | — | — | — | — |
| | (cellulose nanofibers, active | | | | | | | | |
| | ingredient: 2.0%) | | | | | | | | |
| | LAPONITE-RD | — | — | — | — | — | — | 3.0 | — |
| | (synthetic hectorite, active | | | | | | | | |
| | ingredient: 100.0%) | | | | | | | | |
| | AEROSIL 200 | — | — | — | — | — | — | — | — |
| | (hydrophilic fumed silica, | | | | | | | | |
| | active ingredient: 100.0%) | | | | | | | | |
| film- | VINYBLAN 755 | — | — | — | — | 7.0 | 7.0 | 7.0 | 7.0 |
| forming | (polyvinyl chloride resin | | | | | | | | |
| agent | emulsion, active ingredient 25%, | | | | | | | | |
| | MFT: 20° C., Tg: 34° C., average | | | | | | | | |
| | particle diameter: 30 nm) | | | | | | | | |
| | VINYBLAN 278 | — | — | — | — | — | — | — | — |
| | (polyvinyl chloride resin | | | | | | | | |
| | emulsion, active ingredient | | | | | | | | |
| | 43%, MFT: 50° C., Tg: 30° C.) | | | | | | | | |
| | VINYBLAN 690 | — | — | — | — | — | — | — | — |
| | (polyvinyl chloride resin | | | | | | | | |
| | emulsion, active ingredient | | | | | | | | |
| | 54%, MFT: 65° C., Tg: 45° C.) | | | | | | | | |
| | VINYBLAN 700 | — | — | — | — | — | — | — | — |
| | (polyvinyl chloride resin | | | | | | | | |
| | emulsion, active ingredient | | | | | | | | |
| | 30%, MFT: 80° C., Tg: 70° C.) | | | | | | | | |
| | VINYBLAN 715S | — | — | — | — | — | — | — | — |
| | (polyvinyl chloride resin | | | | | | | | |
| | emulsion, active ingredient | | | | | | | | |
| | 24%, MFT: 0° C., Tg: 25° C.) | | | | | | | | |
| | VONCOAT SA-6360 | 3.0 | — | — | — | — | — | — | — |
| | (acrylic-silicone resin emulsion, | | | | | | | | |
| | active ingredient: 50%, MFT: 26 | | | | | | | | |
| | to 32° C., Tg: 21° C., average | | | | | | | | |
| | particle diameter: 150 nm) | | | | | | | | |
| | VONCOAT CG-8400 | — | 3.0 | — | — | — | — | — | — |
| | (acrylic-styrene resin emulsion, | | | | | | | | |
| | active ingredient: 50%, MFT: 26 | | | | | | | | |
| | to 31° C., Tg: 25° C., average | | | | | | | | |
| | particle diameter: 150 to 200 nm) | | | | | | | | |
| | VONCOAT 5400EF | — | — | 3.0 | — | — | — | — | — |
| | (acrylic-styrene resin emulsion, | | | | | | | | |
| | active ingredient: 55%, MFT: 5 | | | | | | | | |
| | to 10° C., Tg: 6° C., average | | | | | | | | |
| | particle diameter: 200 nm) | | | | | | | | |
| | VONCOAT CG -5010EF | — | — | — | 3.0 | — | — | — | — |
| | (acrylic-urethane resin emulsion, | | | | | | | | |
| | active ingredient: 45%, MFT: 20 | | | | | | | | |
| | to 23° C., Tg: 29° C., average | | | | | | | | |
| | particle diameter: 100 to 150 nm) | | | | | | | | |
| functional | JS-A191 | 86.0 | 86.0 | 86.0 | 86.0 | 80.0 | 80.0 | 86.0 | 80.0 |
| particles | (silver nanoparticle dispersion, | | | | | | | | |
| | active ingredient: 40%, average | | | | | | | | |
| | particle diameter: 30 to 50 nm) | | | | | | | | |
| solvent | ethylene glycol | — | — | — | — | 6.0 | — | — | — |
| | glycerin | — | — | — | — | — | 6.0 | — | 10.0 |
| total (parts by mass) | | 96.0 | 96.0 | 96.0 | 96.0 | 100.0 | 100.0 | 96.0 | 100.0 |
| physical | ratio A/B of the average | 0.2 to 0.3 | 0.15 to 0.3 | 0.15 to 0.25 | 0.2 to 0.5 | 1 to 1.67 | 1 to 1.67 | 1 to 1.67 | 1 to 1.67 |
| property | particle diameter A of the | | | | | | | | |
| value | functional particles to the | | | | | | | | |
| | average particle diameter B | | | | | | | | |
| | of the film forming agent | | | | | | | | |

TABLE 4

| | | comparative example | | | | |
|---|---|---|---|---|---|---|
| | | 1 | 2 | 3 | 4 | 5 |
| liquid for porous material | | 19 | 20 | 21 | 22 | 23 |
| thickner | AQ-633E | 7.0 | — | — | — | 7.0 |
| | (modified polyamide, active | | | | | |
| | ingredient: 22.5%) | | | | | |
| | AQH-800 | — | — | — | — | — |
| | (modified polyamide, active | | | | | |
| | ingredient: 10.0%) | | | | | |
| | RHEOBYK-425 | — | — | — | — | — |
| | (modified polyamide, active | | | | | |
| | ingredient: 50.0%) | | | | | |
| | RHEOCRYSTA I-2SX | — | — | — | — | — |
| | (cellulose nanofibers, active | | | | | |
| | ingredient: 2.0%) | | | | | |
| | LAPONITE-RD | — | — | — | 4.0 | — |
| | (synthetic hectorite, active | | | | | |
| | ingredient: 100.0%) | | | | | |
| | AEROSIL 200 | — | — | — | — | — |
| | (hydrophilic fumed silica, | | | | | |
| | active ingredient: 100.0%) | | | | | |
| film- | VINYBLAN 755 | — | 7.0 | — | — | — |
| forming | (polyvinyl chloride resin | | | | | |
| agent | emulsion, active ingredient 25%, | | | | | |
| | MFT: 20° C., Tg: 34° C., average | | | | | |
| | particle diameter: 30 nm) | | | | | |
| | VINYBLAN 278 | — | — | — | — | — |
| | (polyvinyl chloride resin | | | | | |
| | emulsion, active ingredient | | | | | |
| | 43%, MFT: 50° C., Tg: 30° C.) | | | | | |
| | VINYBLAN 690 | — | — | — | — | — |
| | (polyvinyl chloride resin | | | | | |
| | emulsion, active ingredient | | | | | |
| | 54%, MFT: 65° C., Tg: 45° C.) | | | | | |
| | VINYBLAN 700 | — | — | — | — | — |
| | (polyvinyl chloride resin | | | | | |
| | emulsion, active ingredient | | | | | |
| | 30%, MFT: 80° C., Tg: 70° C.) | | | | | |
| | VINYBLAN 715S | — | — | — | — | — |
| | (polyvinyl chloride resin | | | | | |
| | emulsion, active ingredient | | | | | |
| | 24%, MFT: 0° C., Tg: 25° C.) | | | | | |
| | VONCOAT SA-6360 | — | — | — | — | — |
| | (acrylic-silicone resin emulsion, | | | | | |
| | active ingredient: 50%, MFT: 26 | | | | | |
| | to 32° C., Tg: 21° C., average | | | | | |
| | particle diameter: 150 nm) | | | | | |
| | VONCOAT CG-8400 | — | — | — | — | — |
| | (acrylic-styrene resin emulsion, | | | | | |
| | active ingredient: 50%, MFT: 26 | | | | | |
| | to 31° C., Tg: 25° C., average | | | | | |
| | particle diameter: 150 to 200 nm) | | | | | |
| | VONCOAT 5400EF | — | — | — | — | — |
| | (acrylic-styrene resin emulsion, | | | | | |
| | active ingredient: 55%, MFT: 5 | | | | | |
| | to 10° C., Tg: 6° C., average | | | | | |
| | particle diameter: 200 nm) | | | | | |
| | VONCOAT CG -5010EF | — | — | — | — | — |
| | (acrylic-urethane resin emulsion, | | | | | |
| | active ingredient: 45%, MFT: 20 | | | | | |
| | to 23° C., Tg: 29° C., average | | | | | |
| | particle diameter: 100 to 150 nm) | | | | | |
| functional | JS-A191 | 93.0 | 93.0 | 100.0 | 96.0 | 81.0 |
| particles | (silver nanoparticle dispersion, | | | | | |
| | active ingredient: 40%, average | | | | | |
| | particle diameter: 30 to 50 nm) | | | | | |
| solvent | ethylene glycol | — | — | — | — | — |
| | glycerin | — | — | — | — | 12.0 |

The “viscosity”, “stability”, “accuracy”, “uniformity”, and “conductivity” of the liquids for porous material 1 to 23 of Examples 1 to 18 and Comparative Examples 1 to 5 were evaluated as follows. The results are listed in Tables 5 and 7.

### Viscosity

The temperature of each of the obtained liquids for porous materials was adjusted to 25° C., and the viscosity at a shear rate of 0.1 (1/s) and 1,000 (1/s) was measured using a rheometer MCR-302 manufactured by Anton Paar, respectively. The results are listed in Tables 5 and 7.

### Stability

Each of the liquids for porous materials was charged into an image forming apparatus including a head (nozzle hole diameter: 60 micrometers (μm)) manufactured by Ricoh Digital Painting Company, Ltd., and droplets were discharged. The stability was evaluated based on the following evaluation criteria from the presence or absence of nozzle clogging and the presence or absence of irregular discharge when the discharged droplets were observed. The results are listed in Tables 5 and 7.

### Evaluation Criteria

Good: No nozzle clogging and no irregular discharge Satisfactory: No nozzle clogging and irregular discharge, or nozzle clogging and no irregular discharge

Poor: Droplets cannot be discharged from the nozzle

### Accuracy

Each of the liquids for porous materials was charged into an image forming apparatus including a head (nozzle hole diameter: 60 μm) manufactured by Ricoh Digital Painting Company, Ltd., and droplets were discharged onto a fiber sheet (manufactured by ORIBEST

CO., LTD., basis weight: 30 grams per square meter (gsm)) as a porous medium heated to 100° C. by a silicon rubber heater under the conditions of a droplet volume of 10 nanoliters (nl), a droplet density of 100 dpi×100 dpi, and a single layering to print a solid image of 40 mm× 40 mm.

The printed fiber sheet was dried at 200° C. in a thermostatic bath for 1 hour, and the printed size was measured to evaluate accuracy based on the following evaluation criteria. The results are listed in Tables 5 and 7.

### Evaluation Criteria

Good: The average value of one side of the printed size is 38 mm or more and less than 42 mm.

Poor: The average value of one side of the printed size is less than 38 mm or 42 mm or more.

### Uniformity

A solid image of 40 mm×40 mm was printed in the same manner as in the evaluation of the pattern accuracy. The printed fiber sheet was dried at 200° C. in a thermostatic bath for 1 hour, and the printed portion was observed under a microscope to evaluate uniformity based on the following evaluation criteria. The results are listed in Tables 5 and 7.

### Evaluation Criteria

Good: The functional particles are attached to the surface of the fiber and the voids between the fibers.

Poor: The functional particles are attached only to the surface of the fiber.

Conductivity

Each of the liquids for porous materials was charged into an image forming apparatus including a head (nozzle hole diameter: 60 μm) manufactured by Ricoh Digital Painting Company, Ltd., and droplets were discharged onto a fiber sheet (manufactured by ORIBEST CO., LTD., basis weight: 30 grams per square meter (gsm)) as a printing medium heated to 100° C. by a silicon rubber heater under the conditions of a droplet volume of 10 nl, a droplet density of 100 dpi×100 dpi, and a single layering to print a solid image of 2 mm×40 mm.

The printed fiber sheet was dried at 200° C. in a thermostatic bath for 1 hour, and a tester was connected to an end of a printed line image to measure the resistance value, and the conductivity was evaluated based on the following evaluation criteria. The results are listed in Tables 5 and 7.

Evaluation Criteria

Good: The resistance value is less than 0.1 ohms (52).

Satisfactory: The resistance value is 0.1 2 or more and less than 1 02.

Poor: The resistance value is 1 62 or more.

TABLE 5

| | | | example | | | | | | | | | |
|---|---|---|---|---|---|---|---|---|---|---|---|---|
| | | | 1 | 2 | 3 | 4 | 5 | 6 | 7 | 8 | 9 | 10 |
| evaluation | viscosity | viscosity (Pa · s) | 4 | 3 | 2 | 15 | 50 | 30 | 4 | 4 | 4 | 4 |
| result | | at shear rate of | | | | | | | | | | |
| | | 0.1 (1/s) | | | | | | | | | | |
| | | viscosity (Pa · s) | 25 | 23 | 20 | 35 | 30 | 40 | 28 | 27 | 24 | 25 |
| | | at shear rate of | | | | | | | | | | |
| | | 1,000 (1/s) | | | | | | | | | | |

| | | | | | | | | | | |
|---|---|---|---|---|---|---|---|---|---|---|
| stability | good | good | good | satisfactory | satisfactory | satisfactory | good | good | good | satisfactory |
| accuracy | good | good | good | good | good | good | good | good | good | good |
| uniformity | good | good | good | good | good | good | good | good | good | good |
| conductivity | good | good | good | good | good | good | good | good | good | good |

TABLE 6

| | | | example | | | | | | | |
|---|---|---|---|---|---|---|---|---|---|---|
| | | | 11 | 12 | 13 | 14 | 15 | 16 | 17 | 18 |
| evaluation | viscosity | viscosity (Pa · s) | 4 | 4 | 4 | 4 | 4 | 5 | 95 | 4 |
| result | | at shear rate of | | | | | | | | |
| | | 0.1 (1/s) | | | | | | | | |
| | | viscosity (Pa · s) | 26 | 27 | 27 | 26 | 21 | 50 | 55 | 96 |
| | | at shear rate of | | | | | | | | |
| | | 1,000 (1/s) | | | | | | | | |

| | | | | | | | | |
|---|---|---|---|---|---|---|---|---|
| stability | good | good | satisfactory | good | good | good | satisfactory | satisfactory |
| accuracy | good | good | good | good | good | good | good | good |
| uniformity | good | good | good | good | good | good | good | good |
| conductivity | good | good | good | good | good | good | satisfactory | good |

TABLE 7

| | | | comparative example | | | | |
|---|---|---|---|---|---|---|---|
| | | | 1 | 2 | 3 | 4 | 5 |
| evaluation | viscosity | viscosity (Pa · s) | 4 | 0.02 | 0.01 | 110 | 4 |
| result | | at shear rate of | | | | | |
| | | 0.1 (1/s) | | | | | |
| | | viscosity (Pa · s) | 23 | 20 | 10 | 65 | 110 |
| | | at shear rate of | | | | | |
| | | 1,000 (1/s) | | | | | |

| | | | | | |
|---|---|---|---|---|---|
| stability | good | good | good | poor | poor |
| accuracy | good | poor | poor | — | — |
| uniformity | poor | poor | poor | — | — |
| conductivity | satisfactory | satisfactory | satisfactory | — | — |

Examples 1 to 6 are examples in which the type of the thickener is changed. Examples 1 to 6 include a thickener and a film forming agent, and in any case, the viscosity (viscosity at a shear rate of 0.1 (1/s) and viscosity at a shear rate of 1,000 (1/s)) satisfies the reference value, and the “stability”, “accuracy”, “uniformity”, and “conductivity” are good. Examples 7 to 14 are examples in which the type of the film forming agent is changed. Examples 7 to 14 include a thickener and a film forming agent, and in any of the film forming agents, the viscosity (viscosity at a shear rate of 0.1 (1/s) and viscosity at a shear rate of 1,000 (1/s)) satisfies the reference value, and the “stability”, “accuracy”, “uniformity”, and “conductivity” are good.

In addition, in Examples 7 to 9, 11, 12, and 14, the minimum film-forming temperature (MFT) of the film-forming agent is 20° C. or more, and the “stability” is better.

Examples 15 and 16 are examples in which a solvent was added. Examples 15 and 16 each contain a thickener, a film-forming agent, and a solvent, and in any of the solvents, the viscosity (viscosity at a shear rate of 0.1 (1/s) and viscosity at a shear rate of 1,000 (1/s)) satisfies the reference value, and the “stability”, “accuracy”, “uniformity”, and “conductivity” are good. Comparative Example 1 is a comparative example in which the film forming agent is not contained in Example 1. Since the film forming agent is not contained, the evaluation of “uniformity” and “conductivity” is poor.

Comparative Example 2 is a comparative example in which a thickener is not contained in Example 1. Since the thickener is not contained, the viscosity is low, and the evaluation of “accuracy”, “uniformity”, and “conductivity” is poor. Comparative Example 3 is a comparative example in which neither the thickener nor the film forming agent is contained in Example 1. Accordingly, the viscosity is low and the evaluation of “accuracy”, “uniformity”, and “conductivity” is poor. From these, it is understood that the viscosity (viscosity at a shear rate of 0.1 (1/s) and viscosity at a shear rate of 1,000 (1/s)) of the thickener and the film forming agent in the liquid for porous materials according to an embodiment of the present disclosure satisfy the reference values, and the liquid for porous materials has good “stability”, “accuracy”, “uniformity”, and “conductivity”.

Aspects of the present disclosure are as follows.

First Aspect

A liquid substance includes a film-forming agent and functional particles, and having a viscosity of 1 Pa·s to 100 Pa·s at a shear rate of 0.1 (1/s) and a viscosity of 1 mPa·s to 100 mPa·s at a shear rate of 1,000 (1/s).

Second Aspect

The liquid substance according to the first aspect further includes thickener. The thickener includes at least one of a resin, a carbon nanotube, a cellulose nanofiber, or a layered clay mineral.

Third Aspect

In the liquid substance according to the second aspect, the thickener is a resin, and the resin is at least one of polyamide, modified polyamide, and fatty acid polyamide.

Fourth Aspect

In the liquid substance according to the second or third aspect, the content of the thickener is 0.1% by mass or more and 10.0% by mass or less with respect to a total amount of the liquid substance.

Fifth Aspect

In the liquid substance according to any one the first to fourth aspects, the film forming agent is a resin emulsion containing at least one of an acrylic resin, a urethane resin, a silicone resin, an acryl-styrene copolymer, an acryl-urethane copolymer, an acryl-silicone copolymer, a polyester copolymer, a vinyl chloride resin, or a vinyl acetate resin as a main component.

Sixth Aspect

In the liquid substance according to any one of the first to fifth aspects, a minimum film-forming temperature of the film-forming agent is 20° C. or higher.

Seventh Aspect

In the liquid substance according to any one of the first to sixth aspects, a content of the film forming agent is 0.1% by mass or more and 10.0% by mass or less with respect to a total amount of the liquid substance.

Eighth Aspect

In the liquid substance according to any one of the first to seventh aspects, a ratio A/B of an average particle diameter A of the functional particles to an average particle diameter B of the film forming agent is 0.1 or more and 10 or less.

Ninth Aspect

The liquid substance according to any one of the first to eighth aspects further includes a solvent containing at least one of ethylene glycol or glycerin.

Tenth Aspect

A method for producing a porous reinforced resin article includes impregnating a predetermined region in a porous medium with the liquid substance according to any one of the first to ninth aspects to apply the liquid substance to the predetermined region in the porous medium, and drying the porous medium.

Eleventh Aspect

In the method according to the tenth aspect, the porous medium is a nonwoven fabric made of any one of glass fiber, carbon fiber, or flux fiber.

Twelfth Aspect

In the method according to the tenth or eleventh aspect, the porous medium is a fiber sheet having a fiber volume fraction of 10% or less.

Thirteenth Aspect

The method according to any one of the tenth to twelfth aspects further includes heating the porous medium.

Fourteenth Aspect

The method according to any one of the tenth to thirteenth aspects further includes moving the porous medium.

Fifteenth Aspect

A system for producing a porous reinforced resin article includes an applying apparatus to impregnate a predetermined region in a porous medium with the liquid substance according to any one of the first to ninth aspects, to apply the liquid substance to the predetermined region in the porous medium, and a drier to dry the porous medium.

The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

1. A liquid substance comprising:
a film-forming agent; and
functional particles, and having:
a viscosity of 1 Pa·s to 100 Pa·s at a shear rate of 0.1 (1/s); and
a viscosity of 1 mPa·s to 100 mPa·s at a shear rate of 1,000 (1/s).

2. The liquid substance according to claim 1, further comprising:
a thickener including at least one of:
a resin;
a carbon nanotube;
a cellulose nanofiber; or
layered clay mineral.

3. The liquid substance according to claim 2,
wherein the thickener includes a resin containing at least one of:
polyamide;
modified polyamide; and
fatty acid polyamide.

4. The liquid substance according to claim 2,
wherein a content of the thickener is 0.1% by mass or more and 10.0% by mass or less with respect to a total amount of the liquid substance.

5. The liquid substance according to claim 1,
wherein the film-forming agent forms a continuous film on a surface of a porous medium, onto which the liquid substance is applied, and
the functional particles impart a predetermined function to the porous medium.

6. The liquid substance according to claim 5,
wherein the film-forming agent includes a resin emulsion including, as a main component, at least one of:
an acrylic resin;
a urethane resin;
a silicone resin;
an acryl-styrene copolymer;
an acryl-urethane copolymer;
an acryl-silicone copolymer;
a polyester copolymer;
a vinyl chloride resin; or
a vinyl acetate resin.

7. The liquid substance according to claim 1,
wherein the film-forming agent has a minimum film forming temperature of 20° C. or higher.

8. The liquid substance according to claim 1,
wherein a content of the film-forming agent is 0.1 mass % or more and 10.0 mass % or less with respect to a total amount of the liquid substance.

9. The liquid substance according to claim 1,
wherein a ratio A/B of an average particle diameter A of the functional particles to an average particle diameter B of the film-forming agent is 0.1 or more and 10 or less.

10. The liquid substance according to claim 1, further comprising a solvent including at least one of ethylene glycol or glycerin.

11. A method for producing a porous reinforced resin article, the method comprising:
applying the liquid substance according to claim 1 to a predetermined region in a porous medium to impregnate the predetermined region in the porous medium with the liquid substance; and
drying the porous medium applied with the liquid substance.

12. The method according to claim 11,
wherein the porous medium includes a nonwoven fabric made of any one of glass fiber, carbon fiber, or flax fiber.

13. The method according to claim 11,
wherein the porous medium includes a fiber sheet having a fiber volume fraction of 10% or less.

14. The method according to claim 11,
wherein the drying comprising heating the porous medium.

15. The method according to claim 11,
wherein the applying comprising moving the porous medium while applying.

16. A system comprising:
a liquid applier to apply the liquid substance according to claim 1 to a predetermined region in a porous medium to impregnate the predetermined region in the porous medium with the liquid substance; and
a dryer to dry the porous medium applied with the liquid substance, to produce a porous reinforced resin article.
